(19) United States
(12) Patent Application Publication
(10) Pub. No.: US 2023/0030427 A1
(43) Pub. Date: Feb. 2, 2023

(54) OPERATING MASTER PROCESSORS IN POWER SAVING MODE

(71) Applicant: Hewlett-Packard Development Company, L.P., Spring, TX (US)

(72) Inventors: Deb Rupam Banjeree, Bangalore (IN); Sunil Kumar B, Bangalore (IN)

(21) Appl. No.: 17/788,492

(22) PCT Filed: Nov. 16, 2020
(86) PCT No.: PCT/US20/70791

§ 371 Date: Jun. 23, 2022

(30) Foreign Application Priority Data
Apr. 3, 2020 (IN) 202041014951

(51) Int. Cl. G06F 1/3293; G06F 9/50; G06F 9/4401

(52) U.S. Cl. CPC G06F 1/3293; G06F 9/5016; G06F 9/4411

(57) ABSTRACT

Techniques of power management in devices having multi-processor core are described herein. In an example, an ethernet controller of a device comprises a MAC layer module which receives a data packet through a physical network. A multi-processor core coupled to the ethernet controller comprises a first and a second processor. The first and second processor comprise a first driver and a second driver, respectively. The second driver determines that the first processor has entered a power saving mode, receives the data packets directed towards the multi-processor core from the MAC layer module and stores the data packet in a data structure. The econd driver invokes the first driver based on a determination that the data packet is to be handled by the first processor and provides an address of the data structure storing the data packet to the first driver, the data structure being accessible to the first driver.

### BACKGROUND

Imaging devices, such as plotters, printers, scanners, and photocopiers render content on a compatible medium on receiving a job from a client device. An imaging device may also be implemented as a multi-functional imaging device. For instance, a multi-functional printer may incorporate, along with its capability to print content, functionality of a scanner and/or functionality of a fax machine. In another example, a scanner may also create a physical copy of a document thereby exhibiting functionalities of a photocopying device.

Devices, such as multifunction printers may be deployed in an organization for serving several users connected to the respective multifunction printers, through a network. These devices cater to multiple users and act like servers that may provide various services, such as print, scan, and fax to the multiple users. Accordingly, such device generally have a high network presence to allow the services to run.

### BRIEF DESCRIPTION OF FIGURES

The following detailed description references the drawings, wherein:

FIG. 1 illustrates a networked environment comprising an imaging device and a plurality of user devices coupled to the imaging device, in accordance with an example implementation of the present subject matter;

FIG. 2 illustrates a device comprising a processor to transition from a power saving mode to an active mode, in accordance with an example implementation of the present subject matter;

FIG. 3 illustrates an imaging device implementing dynamic power management techniques to operate a processor in a power saving mode, in accordance with an example implementation of the present subject matter;

FIG. 4 illustrates the imaging device implementing the techniques to operate the processor in a power saving mode, in accordance with another example implementation of the present subject matter;

FIG. 5 illustrates the multi-processor core, in accordance with another example implementation of the present subject matter;

FIG. 6 illustrates a method to transition a processor from a power saving mode to an active mode, according to an example of the present subject matter;

FIG. 7 illustrates a communication flow that takes place in order to make a determination at step 618 of the method to transition the processor from the power saving mode to the active mode, according to an example of the present subject matter;

FIG. 8 illustrates a communication flow that takes place in a scenario where first and second applications of the respective processors coordinate to process the data packets received from the physical network, according to an example of the present subject matter;

FIG. 9 illustrates a computing environment implementing a non-transitory computer-readable medium for operating a processor in a power saving mode, according to an example of the present subject matter.

### DETAILED DESCRIPTION

According to existing static power management (PM) techniques, a device, such as a multifunction printer, wakes up or sleeps as a whole maintaining an application driven power state. For example, if a component that is responsible for print operation in the multifunction printer is operating, other components of the multifunction printer, such as components responsible for scan or fax operation, cannot remain in a sleep state. However, such PM techniques may not be efficient in case of devices incorporating heterogeneous multi-processing, wherein more than one kind of processor cores, incorporating specialized processing capabilities to handle dedicated operations, are used to gain performance or energy efficiency, static PM techniques may be ineffective.

A dynamic PM model, where individual components may perform respective energy savings without an application driven power state is generally implemented in devices incorporating heterogeneous multi-processing. For example, in a multifunction printer having dedicated processor cores for network packet filtering, scan, fax, copy, and print dynamic power management techniques may be implemented in firmware to optimize power consumption.

In a big-little processor architecture of heterogeneous multi-core processing, relative energy-saving and slower processor cores (little) are coupled with relatively more powerful and power-intensive (big) processor cores. In an example, the big processor core and the little processor core may also function as a master and a slave processor, respectively, of a master-slave processing architecture, wherein the master may be more powerful than the slave processors and be provided control over the slave processor.

In such architectures, the task of network packet filtering is generally offloaded to the little processor core consuming low power. The little processor core monitors network packets and implements network packet filtering techniques. The little processor core runs a network stack and fewer services that can respond to network requests. On receiving a data packet which the little processor core is unable to handle, the little processor core wakes up the big processor core. This allows the big processor to handle the data packet and avoid inadvertent scenarios, such as denial of service. The process of waking up the big processor core may involve transfer of data packets from the little processor core to the big processor core. This process results in redundancy, since the data packets are copied at multiple instances, e.g., by little processor and then by big processor core. This in turn makes the power management process inefficient.

According to an example of the present subject matter, techniques of dynamic power management in devices having a multi-processor core, such as a multifunction printer are described herein. The dynamic power management techniques described herein provide for operating the big processor core, also referred to as the master processor, in a power saving mode, such that the process of transition of the master processor from the power saving mode to an active mode eliminates loss of data packets and minimizes the transition time involved.

According to an example implementation of the present invention, a device comprising a multi-processor core is described. In an example, as evident from the term “multi-processor core”, each core of the multi-processor core of the device may have multiple processors. For instance, the device may comprise an application specific integrated circuit comprising a master processor and a slave processor. The slave processor is such that it consumes lower power as compared to the master processor. The master processor is interchangeably referred to as a first processor or master core and similarly the slave processor is interchangeably referred to as a second processor or slave core. The terms processor, processor core, and core have also been interchangeably used.

In an implementation, the master processor may operate in one of an active mode or power saving mode. In the power saving mode, the master processor remains in a low energy or powered off state, while the slave processor, consuming low power, is kept active for service availability of the device.

The device may further comprise an ethernet controller that includes a first dedicated direct memory access (DMA) channel and a second DMA channel for transmitting data to the master processor and slave processor, respectively, and a device port interfacing the device to a physical network. The ethernet controller also comprises a Medium Access Control (MAC) layer module. The MAC layer module receives a data packet from other devices through the physical network. Based upon a determination that the master processor is operating in the active mode and that the data packet is addressed to the master processor, the MAC layer module transfers the data packet to the first DMA channel and when it is determined that the master processor is operating in the power saving mode, the MAC layer module transfers the data packet to the second DMA channel.

Each of the first and second DMA channels has a dedicated data structure. A first data structure of the first DMA channel stores the data packet received from the MAC layer module and is accessible to the master processor.

Likewise, a second data structure of the second DMA channel stores the data received from the MAC layer module and is accessible to the slave processor. In an example implementation, the second data structure of the second DMA channel is accessible to the master processor as well.

The master processor comprises a first driver that communicates with the slave processor and the ethernet controller. The slave processor also comprises a second driver that communicates with the master processor and the ethernet controller. When the master processor decides to switch to the power saving mode from the active mode, the first driver sends a notification to the second driver which in turn sends a notification to the MAC layer module. When the master processor operates in the power saving mode, on receiving a data packet from the MAC layer module through the second DMA channel, it is determined whether the data packet received is to be handled by the master processor or the slave processor. In case, if it is determined that the data packet is to be handled by the master processor, then the second driver sends, to the first driver, a pointer to an address of the second data structure where the data packet is stored.

Thus, the two different drivers running on the master and the slave processor, respectively, are enabled to control the data transmission between the MAC layer module and the master or the slave processors. Since dedicated channels are used for different processors and the data structure of the slave processor is accessible to the master processor, packet drops that may otherwise happen during the transition of the packets from the slave processor to the master processor can be obviated. Also, the transition time involved in transmitting the data packets to the master processor is reduced, since, instead of transmitting the whole data packet to the master processor, a pointer to the data structure corresponding to the data packet is transferred to the master processor and master processor can access the data packet directly from the respective location.

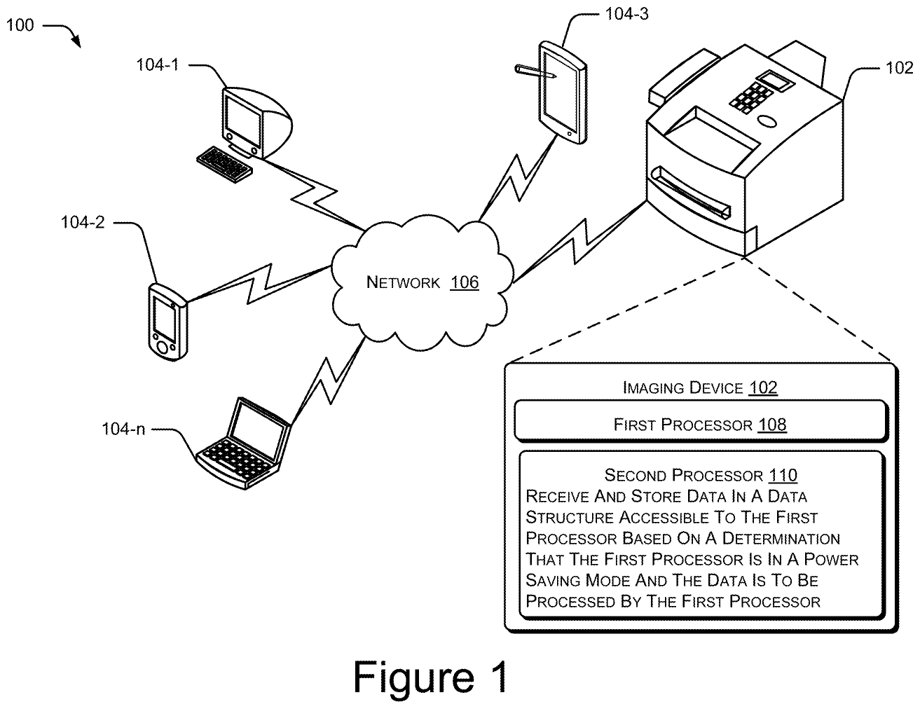

The above techniques are further described with reference to FIG. 1 to FIG. 7. It should be noted that the description and the figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows a networked environment 100 comprising an imaging device 102 and a plurality of user devices 104-1, 104-2, . . . and 104-n coupled to the imaging device 102 according to an example of the present subject matter. Examples of imaging device 102 include plotters, printers, scanners, digital senders, single function printer (SFP), multi-function printer (MFP), and photocopiers. In an example, a plurality of imaging devices may be present in the networked environment 100, however, for the simplicity, the imaging device 102 alone is shown in FIG. 1.

The imaging device 102 may be accessed by the plurality of user devices 104-1, 104-2, . . . and 104-n via a network 106 for using functionalities of the imaging device 102. Examples of the user devices 104-1, 104-2, and 104-3 may include, but are not limited to, electronic devices, such as, desktop computers, laptops, smartphones, personal digital assistants (PDAs), and tablets. The plurality of user devices 104-1, 104-2, . . . and 104-n may issue jobs to the imaging device 102 to utilize the functionality of the imaging device 102. Examples of the jobs may comprise print jobs, scan jobs, or jobs to create copies of a document by scanning the document as well as printing the scanned content on a media.

In an example, the imaging device 102 may receive requests from the plurality of user devices 104-1, 104-2, . . . and 104-n, over the network 106. Also, the user devices 104-1, 104-2, . . . and 104-n may exchange information through the network 106. In an example, the network 106 may be a single network or a combination of multiple networks and may use a variety of different communication protocols. The network 106 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 106 may include various network entities, such as, gateways, routers; however, such details have been omitted for the sake of brevity of the present description.

The imaging device 102 providing services to the user devices 104-1, 104-2, . . . and 104-n may have a high network presence for service availability. Also, the user devices 104-1, 104-2, . . . and 104-n exchanging information through the network 106 may require high network presence, for example, for the avoidance of any data loss. However, providing ceaseless network availability to the imaging device 102 and the user devices 104-1, 104-2, . . . and 104-n also increases the power consumption by these devices. Accordingly, dynamic power management techniques may be implemented in the devices to enable power conservation. It will be understood that the techniques of dynamic power management described herein may be implemented in any of the plurality of imaging devices, for example, the imaging device 102, or in any of the plurality of user devices 104-1, 104-2, . . . and 104-n, that may comprise a multi-core processing architecture having a multi-processor core.

A device, for example, the imaging device 102 or a user device 104-1 comprise a plurality of processors. The plurality of processors may be similar or non-similar in terms of the functionalities and configuration. In accordance with an example implementation of the present subject matter, dynamic power management in a device comprising the multi-core processor provides for at least one of the plurality of processors of the multi-core processor to remain in a power saving mode for energy saving irrespective of the other processors of the multi-core processor.

For example, a device may implement a heterogeneous multi-processor core comprising a plurality of processors having a different kind of processing capabilities to handle dedicated tasks. For instance, consider the device to be the imaging device 102 configured as a multi-functional printer. The imaging device 102 may be capable of performing a print operation, a scan operation and a fax operation, wherein each of the various operations may be handled by a dedicated processor included in the multi-processor core, say, one processor for each of the print operation, the scan operation and the fax operation.

In the heterogenous multi-processor core, some processors may be consuming more power than other processors. Accordingly, the task of filtering network packets may be assigned to a processor that consumes less power, such that the same may be operational to keep the imaging device 102 available for service, while the other processors, such as a processor that consumes higher power may be put in the power saving mode to save power.

There may be a case when the processor (or group of processors) that consumes higher power, referred to as the first processor 108, operates in the power saving mode. In such a case, on receiving a data packet directed towards the first processor 108, the processor that consumes less power, referred to as the second processor 110, that is assigned the task of filtering network packets, may invoke the first processor 108. In accordance with an example implementation of the present subject matter, the process of transition of the first processor 108 from the power saving mode to an active mode is such that transition takes significantly less time and no loss of data packets occurs.

When the first processor 108 operates in a power saving state, the second processor 110 receives data packet directed towards the first processor 108 and stores the data packet in a data structure accessible to the first processor 108 based on a determination that the data packet is to be processed by the first processor 108. The data structure may be implemented in a buffer area of a memory of the imaging device 102. The data structure represents the organization of data packets in the buffer area and decides the retrieval of the data packets from the buffer area. In an example, the data structure may be implemented as a ring. The second processor 110 may then notify the first processor 108 and send a pointer to an address of the data structure, where the data is stored, to the first processor 108. The first processor 108 may then retrieve the data from the respective location to process the same. Thus, the transition time involved in transmitting the whole packet to the first processor 108 is reduced and also the risk of data loss in transit may be avoided.

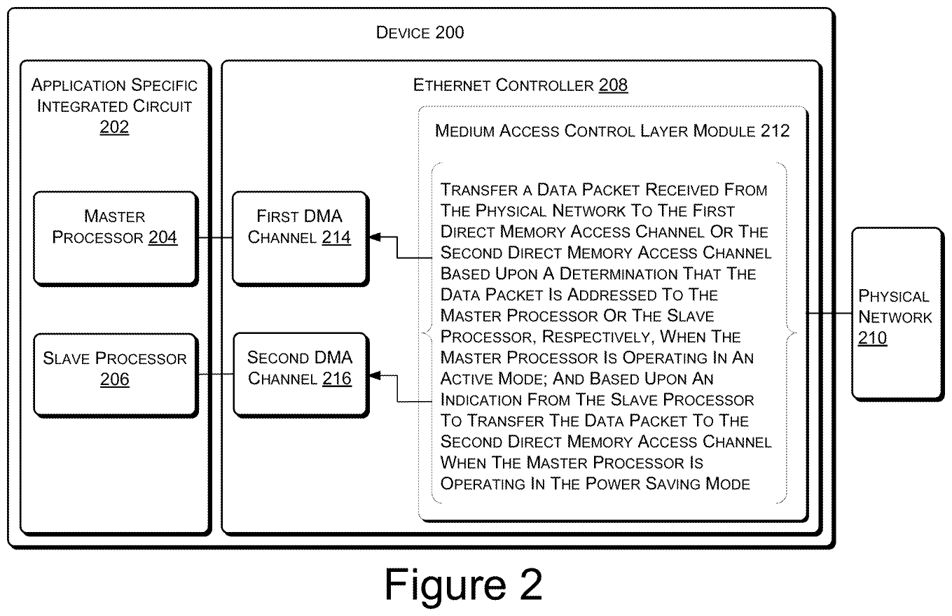

Reference is made to FIG. 2 to explain the transition of a processor of a device 200 from the power saving mode to the active mode, in accordance with one implementation of the present subject matter.

FIG. 2 shows the device 200, according to an example of the present subject matter. The device 200 may comprise an Application Specific Integrated Circuit (ASIC) 202. The ASIC 202 may be an integrated circuit chip designed for predefined tasks. The ASIC 202 comprises a master processor 204, and a slave processor 206 communicatively coupled to the master processor 204. The master processor 204 may operate in a power saving mode or an active mode depending on tasks that the ASIC 202 is to perform. The master processor 204 may be configured to perform different operations than that performed by the slave processor 206. The master processor 204 may have higher computational capability than the computational capability of the slave processor 206.

The device 200 may further comprise an ethernet controller 208 communicatively coupled to the ASIC 202. The ethernet controller 208 interfaces the device with a physical network 210. The physical network 210 may be similar to the above described network, through which the device 200 may communicate with other devices, such as the above described user devices 104-1, 104-2, . . . and 104-n or the imaging device 102. The ethernet controller 208 may comprise a medium access control (MAC) layer module 212 that receives data packet through the physical network 210. The data packet may be directed towards master processor 204 or the slave processor 206 and consequently is to be processed by the corresponding processor.

In an example implementation, the ethernet controller 208 may further comprise a first direct memory access (DMA) channel 214 and a second direct memory access (DMA) channel 216. The first and second DMA channels 214, 216 transmit data packet received by the MAC layer module 212 to a memory of the device 200 from where the respective processor may consume the data packet. The first DMA channel 214 may be associated with a first data structure accessible to the master processor 204 and the second DMA channel 216 may be associated with a second data structure accessible to both the master processor 204 and the slave processor 206.

In an example, the slave processor 206 and the MAC layer module 212 may be aware whether the master processor 204 is operating in the active mode or the power saving mode. If the master processor 204 is operating in the active mode, the MAC layer module 212 transfers the data packet to the first DMA channel 214 when the data packet is addressed to the master processor 204. In case the data packet is addressed to the slave processor 206, the data packet is transferred to the second DMA channel 216. However, if it is determined that the master processor 204 is operating in the power saving mode, based upon an indication from the slave processor 206, the MAC layer module 212 may transfer the data packet to the second DMA channel 216. In such a case, each data packet is transferred to the second DMA channel 216 irrespective of whether the data packet is addressed to the master processor 204 or the slave processor 206.

The first DMA channel 214 stores the data packet received from the MAC layer module 212 in the first data structure (not depicted in FIG. 2), while the second DMA channel 216 stores the data packet received from the MAC layer module 212 in the second data structure. Since the data structure associated with the second DMA channel 216 is accessible to the master processor 204, the data corresponding to the master processor 204 transferred to second DMA channel 216 in the duration that the master processor 204 is in the sleep mode, may be retrieved from the second data structure and processed by the master processor 204, when the master processor 204 wakes up or enters into the active mode. This provides for an efficient transition of the master processor 204 from the power saving mode to the active mode.

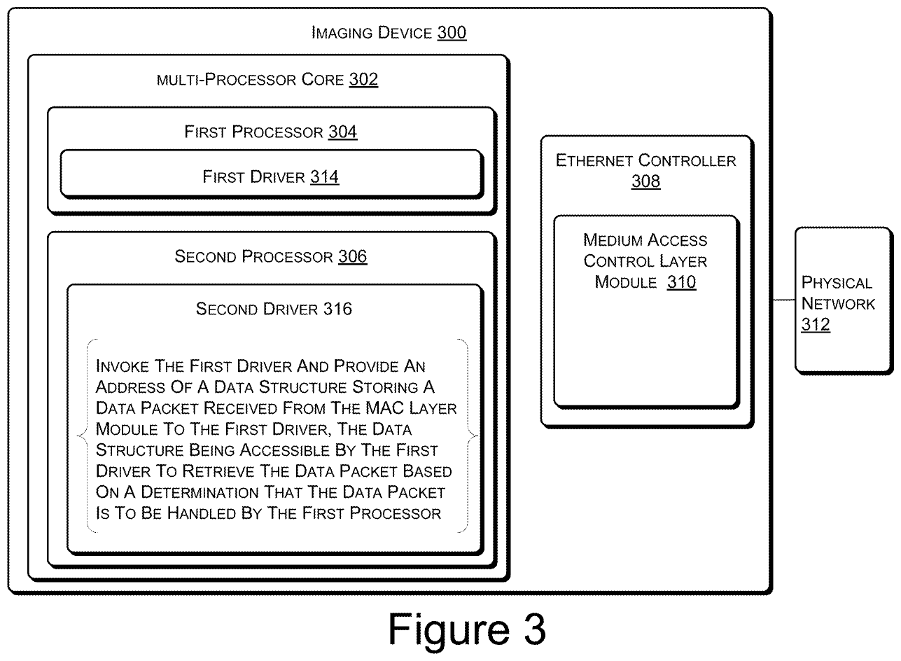

FIG. 3 shows an imaging device 300, according to an example of the present subject matter. The imaging device 300 comprises an ethernet controller 308 and a multi-processor core 302 coupled to the ethernet controller 308. The ethernet controller 308 handles the transmission of a data packet between a memory of the imaging device 300 and a physical network 312. According to an example of the present subject matter, the ethernet controller 308 comprises a MAC layer module 310. The MAC layer module 310 receives the data packet from the physical network 312. The physical network 312 may be similar to network 106 as described above.

In an example, the multi-processor core 302 is a heterogeneous core comprising at least a first processor 304 and a second processor 306 having dissimilar configurations. For example, the first processor 304 may be more power-consuming than the second processor 306. The first and second processors 304, 306 may comprise drivers, namely a first driver 314 and a second driver 316, respectively, to interface the respective processor 304, 306 to the ethernet controller 308. The first and second drivers 314, 316 may be understood as ethernet drivers that enable the imaging device 300 to communicate with other devices through the physical network 312 by interfacing the respective processor 304, 306 to the ethernet controller 308 which in turn couples to the physical network 312.

In operation, when the first processor 304 enters a power saving mode, the second driver 316 may be notified by the first driver 314 that the first processor 304 has entered the power saving mode. The second driver 316 may in turn notify the MAC layer module 310 about the same. Upon the first processor 304 entering the power saving mode, the second driver 316 begins to handle the data packet from the MAC layer module 310 directed to the multi-processor core 302. The data packet received by the second driver 316 may be directed towards the first processor 304 or the second processor 306. The second driver 316 stores the data packet in a data structure.

In an example, in case it is determined that the data packet received from the MAC layer module 310 is to be handled by the first processor 304, the second driver 316 invokes the first driver 314 and provides an address of the data structure storing the data packet to the first driver 314. As mentioned previously, the data structure is accessible to the first driver 314 to retrieve and process the data packet. Since the data structure of the second driver 316 is accessible to the first driver 314, packet drops that may occur in the interim that the first processor 304 resumes the active state is avoided.

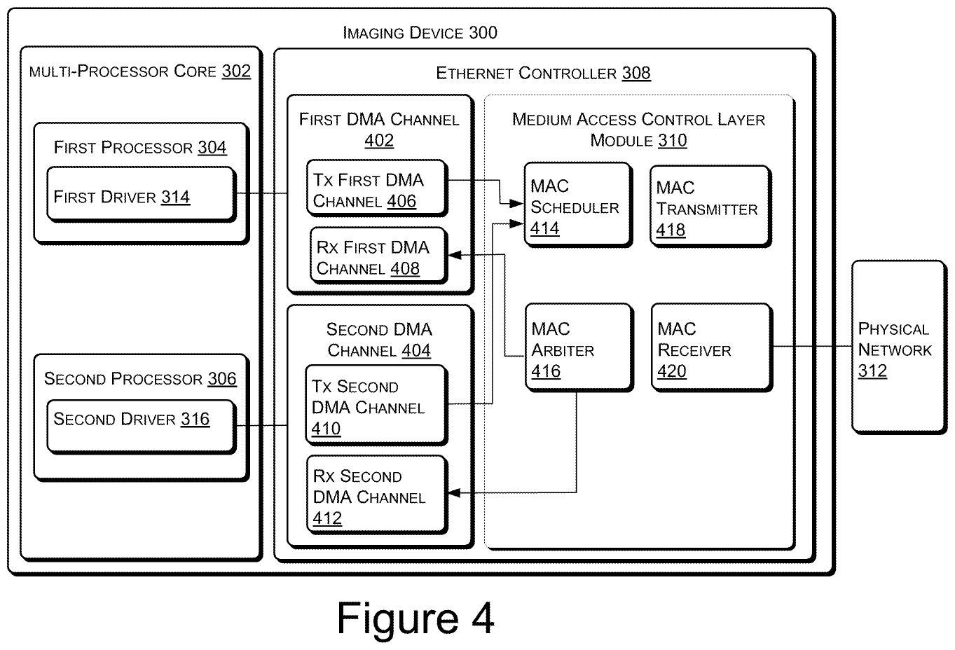

FIGS. 4 illustrates the imaging device 300 implementing techniques to operate the processor in a power saving mode, in accordance with another example of the present subject matter. As mentioned above, the imaging device 300 may comprise the ethernet controller 308 and the multi-processor core 302 coupled to the ethernet controller 308. The multi-processor core 302 may comprise the first processor 304 and the second processor 306, the first processor 304 and the second processor 306 being similar to the above-mentioned master processor 204 and slave processor 206, respectively. It will be understood that while the illustrated implementation depicts the second processor alone, the multi-processor core 302 may include more than one second processor(s) or slave processor(s).

In an example, the first processor 304 and the second processor(s) 306 may be implemented as microprocessors, microcomputers, microcontrollers, digital signal processors, central processing units, state machines, logic circuitries, and/or any devices that manipulate signals based on operational instructions. In an example, the first processor 304 and second processor 306 may have similar or dissimilar configurations. For instance, the first processor 304 may be more powerful and power consuming than the second processor 306. Each of the first and second processors 304, 306 may be assigned dedicated tasks. For example, if the imaging device 300 is a multifunction printer, each of the first and second processors 304, 306 may be configured to perform one of network packet filtering, print, scan or fax operation.

According to an example implementation of the present subject matter, the first and second processors 304, 306 may comprise the first driver 314 and the second driver 316, respectively. As stated above, the first and second drivers 314, 316 may interface the respective processors with the ethernet controller 308 which is coupled with the physical network 312 to allow the imaging device 300 to communicate with other devices over the physical network 312. The first and second drivers 314, 316 facilitates the communication between the first and the second processor 304, 306. Separate buffer spaces in a memory (not shown in the figure) of the imaging device 300 are allocated to each of the first and the second driver 314, 316 for a first data structure and a second data structure of the first driver 314 and the second driver 316, respectively. The first and second data structures provide a storage format for organizing the data packets in the buffer area and provides a way to access the data packets. The memory may include any computer-readable memory, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In an example, the ethernet controller 308 also comprises the MAC layer module 310 which receives the data packets from other devices over the physical network 312. A module may include routines, programs, objects, components, data structures, and the like, which perform particular tasks or implement particular abstract data types. In addition to the MAC layer module 310, the imaging device 300 may include other module(s) that supplement applications on the imaging device 300, for example, modules of an operating system. In one example, the MAC layer module 310 and other module(s) may reside in the memory of the imaging device 300.

A MAC receiver 420 of the MAC layer module 310 may receive the data packets from the physical network 312. The MAC layer module 310 also comprises a MAC transmitter 418 to transmit data packets received from the first and second processors 304, 306 to other devices over the physical network

In an example, the ethernet controller 308 comprises a first DMA channel 402 and a second DMA channel 404 enabling the transmission of a data packet between the first or the second processor 304, 306, respectively, and a device port of the imaging device 300 which interfaces the ethernet controller 308 with the physical network 312. Each of the first and second DMA channels 402, 404 may in turn implement a pair of channels, wherein the pair may include one channel to receive data and one channel to transmit the data packet. In an example implementation, each of the first and the second DMA channels 402, 404 comprises a pair of transmission ring and a receiver ring, named a Tx first DMA channel 406; an Rx first DMA channel 408 and a Tx second DMA channel 410; an Rx second DMA channel 412. The receiver ring 408, 412 of the first and the second DMA channels 402, 404, i.e., Rx first DMA channel 408 and Rx second DMA channel 412 receive the data packets received by the MAC receiver 420. Likewise, the transmission rings 406, 410 of the first and the second DMA channels 402, 404, i.e., the Tx first DMA channel 406 and the Tx second DMA channel 410 transfer the data packets from the first and second processors 304, 306, respectively, to the MAC layer module 310 which may further transmit the data packet to other devices through the physical network 312. Each of the first and second DMA channels 402, 404 maintains a corresponding data structure, mapping to the corresponding data structure of the first and second driver 314, 316. A MAC scheduler 414 of the MAC layer module 310 may store, albeit temporarily, the data packets received from the first and second DMA channels 402, 404 and to be transmitted to the other devices.

In one example implementation, the first processor 304 may be enabled to access the receive Rx ring 412 of the second DMA channel 404. In an example, during initialization/reinitialization of the drivers 314, 316, a handshake operation may be performed between the first and the second driver 314, 316 through a technique of inter-processor communication, for example, a message passing protocol. The handshake allows the second driver 316 to share its data structure with the first driver 314. Accordingly, the first processor 304 may become aware of the receiver Rx ring 412 of the second DMA channel 404. Thus, a data packet received in the Rx ring 412 of the second DMA channel 404 may be accessed by the first driver 314.

In an example, the MAC layer module 310 may further comprise a MAC arbiter 416. The MAC arbiter 416 may route the data packet received by the MAC receiver 420 to an appropriate processor of the multi-processor core 302 based on the operating state of the processors, target address of the data packet and capabilities of the processors to handle the data packet. The MAC arbiter 416 may be implemented through routines, programs, objects, components, data structures, and the like, which perform particular tasks or implement particular abstract data types.

In operation, when the first processor 304 operates in the active mode, based on a determination that the data packet received by the MAC receiver 420 is addressed to the first processor 304, the MAC arbiter 416 sends the data packet addressed to the first processor 304 to the first DMA channel 402. The receiver ring 408 of the first DMA channel 402 stores the data packet in the first data structure of the first driver 314. The first processor 304 may retrieve the data packets from the first data structure. Further, if it is determined that the data packet received is addressed to the second processor(s) 306, the MAC arbiter 416 sends the data packet to the second DMA channel 404 and accordingly, the receive ring 412 of the second DMA channel 404 stores the data packet in the second data structure of the second driver 316.

Further in accordance with example implementations of the present subject matter, the first processor 304 may be operated in a power saving mode to conserve power. In an example, the imaging device 300 may implement a policy for power saving based on a predetermined time period. Accordingly, for the predetermined time period, the processor(s) of the multi-processor core 302 can be put in power saving mode. In another example, policy for power saving can be implemented based on historic data. For example, if historic data reveals that no requests are received from the user devices on given days, such as weekends or for a given duration during any day, for instance, non-working hours of an organization, a policy may be implemented to put the processor(s) in power saving mode during such times.

When the first processor 304 initiates the power saving mode, the first driver 314 of the first processor 304 sends an indication to the second driver 316 through the technique of inter-processor communication. The second driver 316 in turn sends an indication of the first processor 304 operating in the power saving mode to the MAC layer module 310. On receiving such an indication by the MAC layer module 310, the arbiter 416 of the MAC layer module 310 starts transmitting the data packets addressed to the first processor 304 to the second DMA channel 404.

With the first processor 304 operating in the power saving mode, data packets received by the MAC receiver 420 are directed to the second DMA channel 404. A data packet, that is received by the MAC receiver 420 and addressed to the second processor 306, when directed to the second DMA channel 404 is handled by the second driver 316 as it would have been irrespective of the first processor 304 being in the power saving mode. However, when a data packet addressed to the first processor 304 is directed to the second DMA channel 404, whilst the first processor 304 is in the power saving mode, the second processor 306 assesses if the first processor 304 is to be invoked to attend to the data packet. For example, the second driver 316 invokes the first driver 314 based upon a configuration of the data packet and capabilities of the second processor 306 to attend the data packet. In an example, once the second processor 306 decides to invoke the first processor 304, the second processor 306 stops any further processing of the data packets and may enter a power saving mode and waits for further instructions from the first processor 304. The instructions may be the indication of first processor 304 entering or operating in the power saving mode.

In case the second processor 306 determines that a data packet, received while the first processor 304 is in the power saving mode, is to be attended by the first processor 304 at that instance, the control of the second processor 306 over the second driver 316 is suspended and is transferred to the first driver 314. This event causes the first processor 304 to be invoked. The first processor 304 thus transitions from the power saving mode to the active mode to resume its operation. Once the first processor 304 is in the active mode, the first driver 314 traverses the receiver ring 412 of the second DMA channel 404 and retrieves the data packets present in the data structure of the second DMA channel 404. Thereafter, the first processor 304 continues its operation in the active mode and processes the data packets present in the data structure of the first DMA channel 402.

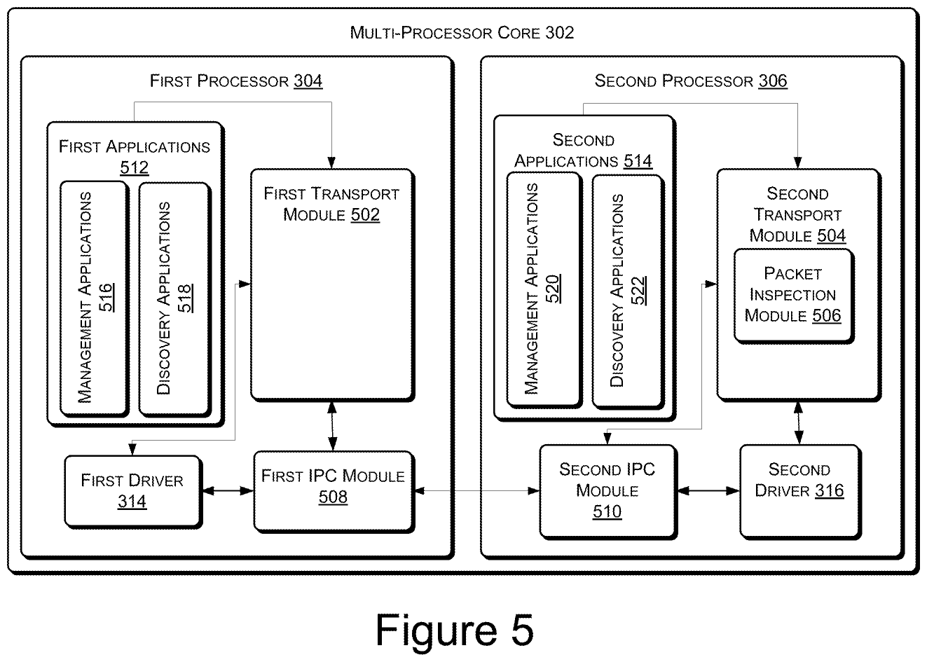

Reference is made to FIG. 5 illustrating the multi-processor core 302, according to an example implementation. The techniques described with reference to FIG. 5, as implemented in the multiprocessor core 302 of the imaging device 300, may also be implemented in the ASIC 202 of the device 200. As described previously, the multiprocessor core 302 comprises the first processor 304 and the second processor 306. In addition to the first driver 314, the first processor 304 may also comprise a first transport module 502 coupled to the first driver 314 and a first inter-processor communication (IPC) module 508. In an example, the first transport module 502 may be understood to comprise layers above the network layer that provides an end to end data transfer between a source and a destination.

In an example, implementation, the first processor 304 may include first applications for processing the data packets received from the physical network 312. In an example, the first applications 512 include management applications 516 and discovery applications 518. The management applications 516 may facilitate various services offered by the devices, such as the imaging device 300.

An example of a management application includes a Simple Network Management Protocol (SNMP) based application that collects and organizes information about other devices on the physical network 312 and modifies the information to change the behavior of the imaging device 300, for example, based on status of the other devices. Other examples of management applications include, but not limited to, Web Services (WS), print protocols, such as cloud printing, AppSocket/JetDirect print, and Line Printer Daemon; and scan protocols, such as Web Scan. The WS may be a collection of protocols used for exchanging data between applications or devices. In an example, the imaging device 300, for example, a printer may support Simple Object Access Protocol (SOAP) based web services which is an XML-based Web service protocol to exchange data and documents over Hyper Text Transfer Protocol (HTTP) or Simple Mail Transfer Protocol (SMTP). In another example, the printer may support Representational State Transfer (REST) based web services which provide communication and connectivity between devices and the internet for API-based tasks.

In an example implementation, the discovery applications 518 collect and organize information about the devices connected to the physical network 312. Further, the discovery applications 518 process the data packets that help devices, such as the imaging device 300 or the device 200 with discovery application installed thereon to get discovered by other devices connected to the physical network 312. In an example, a broadcast/multicast based Network Protocol such as LLMNR (Link Local Multicast Name Resoloution), Bonjour (mDNS), SLP (Service Location Protocol) may be used for such purposes.

Similar to the first processor 304, the second processor 306, may comprise a second transport module 504 coupled to the second driver 316 and a second IPC module 510. The second transport module 504 determines whether the data packet received from the MAC layer module 310 is to be handled by the first processor 304 or the second processor 306 when the first processor 304 is operating in the power saving mode. For the purpose, the second transport module 504 may be implement a sub-module called a packet inspection module 506 which makes such determination. The packet inspection module 506 inspects the data packet transferred to the second DMA channel 404 to determine whether the data packet is to be handled by the first processor 304 or the second processor 306. Further, the second processor 306 also comprises second applications 514, such as the management applications 520 and discovery applications 522.

In an example implementation, the first and second applications 512, 514 have a distributed architecture, i.e., features of an application may reside in both first and second processors 304, 306. For example, features of the respective application that consume more memory and processing resources may reside in the first processor 304 which may be more powerful than the second processor 306 in terms of processing capabilities.

The first transport module 502 and the second transport module 504 together form an inter-processor communication channel that facilitates the communication between the first and the second processor 304, 306. The first driver 314 and the second driver 316 communicate with each other through this inter-processor communication channel. In an example, the first and second IPC module 508, 510 forming this IPC channel may be implemented through a technique of inter-processor communication, for example, a message passing protocol.

In an example, the first processor 304 maintains filtering rules or patterns to filter the data packets received from the physical network 312. The filtering rules are defined by the first processor 304 to indicate types of data packets to be processed by the second processor 306. The filtering rules may either be preset or dynamically configured based upon information gathered through the processing of data packets. That is, the filtering rules are modifiable by the first processor at run-time of the imaging device 300. In an example, the preset filtering rules may comprise a MAC address of the first processor 304 which is set by the manufacturer during manufacturing of the processor board or chip. The MAC address may be passed by the first processor 304 to the second processor 306 or alternatively, the second processor 306 may read the MAC address of the first processor 304 from the hardware, i.e., the multiprocessor core. In an example, dynamic filtering rules may be based on IP addresses of the devices connected to the physical network 312.

The dynamic rules may also be based on object identifiers (OIDs) of simple network management protocol (SNMP) which, as mentioned previously, collects and organizes information about managed devices on the physical network 312 and modifies the information to change the behavior of the imaging device 300, for example, based on status of the managed devices. The SNMP 01Ds may be an address used to identify devices and their statuses or behaviors. Further, the SNMP 01Ds point to network objects stored in a database called the Management Information Base (MIB) which may be a tree-based structure in an example. For example, an OID of SNMP for a printer, i.e., “1.3.6.1.2.43.11.1.1.6.0.2” may represent a yellow ink level in the printer. Accordingly, in an example, a dynamic filtering rule may be defined by the first processor 304 for the second processor 306 to perform a predefined processing of a type of data packets based on a level of yellow ink in the imaging device 300.

The first driver 314 sends filtering rules or patterns to the transport module of the second processor 306, i.e., the second transport module 504. In an example, having the filtering rules provided to the transport module 504 of the second processor 306, when the first processor 304 decides to enter the power saving mode, the first driver 314 sends an indication to the second processor 306. In an example, the indication may be sent by the first driver 314 to the second driver 36 through the IPC channel formed by the first IPC module 508 and the second IPC module 510. The second driver 316 may in turn communicate the indication of the first processor 304 initiating the power saving mode to the MAC layer module 310. Based upon said received indication, the arbiter 416 of the MAC layer module 310 may send all the data packet received through the physical network 312 to the second DMA channel 404. Accordingly, when the first processor 304 operates in the power saving mode, the data packet received by the second driver 316 from the physical network and addressed to the first processor 304 is forwarded to the second transport module 504 and in turn to the packet inspection module 506. The second transport module 504 determines whether the data packet received is to be handled by the first processor 304 or the second processor 306 based on filtering rules which indicates types of data packets to be processed by the second processor 306. Based on the filtering rules, if it is determined that the data packet is to be handled by the second processor 306 then the second transport module 504 sends the data packet to the respective application in the second applications 514. The corresponding second application in the second applications 514 may either process the data packet or return an indication of its inability to process the data packet to the second transport module 504, depending on the features of the corresponding second application implemented at the second processor 306 as explained above.

If it is determined that the data packet is to be processed by the first processor 304 or on receiving the indication of the inability of the second application to process the data packet, the second transport module 504 causes the master processor 204 to be invoked to process the data packet. In that case, the second transport module 504 sends an indication to invoke the first processor 304 to the second driver 316 which in turn sends instructions to invoke the first processor 304 through the IPC channel. As described previously, the second driver 316 also provides an address of the data structure storing the data packet to the first driver 314 which is accessible by the first driver 314 upon entering the active mode. The first processor 304 may then retrieve and process the data packet.

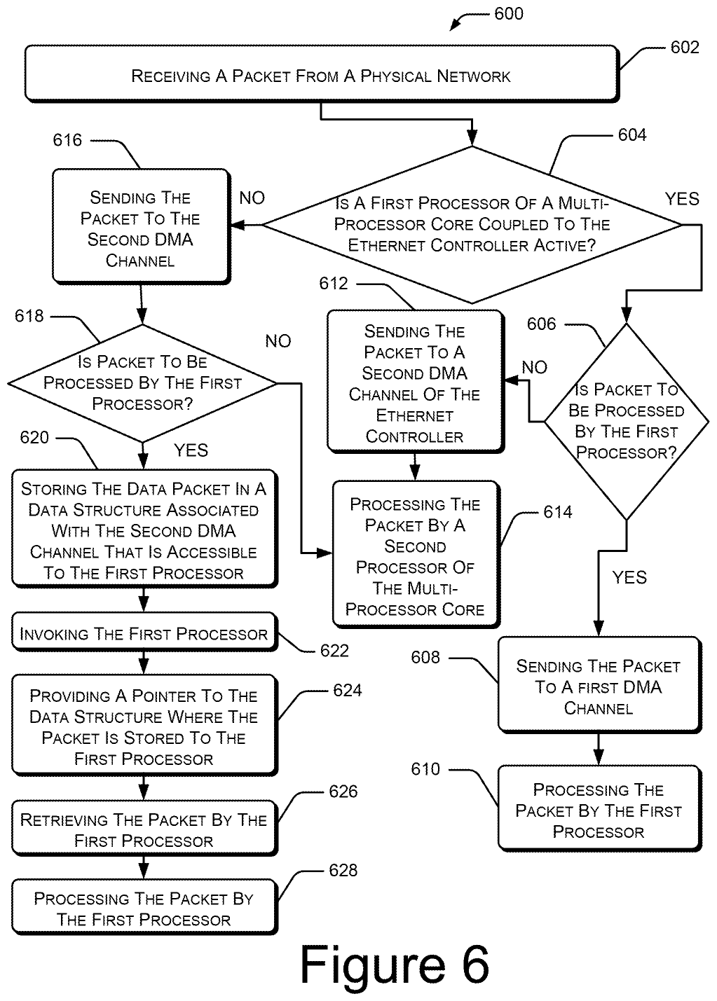

FIG. 6 illustrates a method 600 to transition a processor from a power saving mode to an active mode, according to an example of the present subject matter. Although the method 600 and may be implemented in a variety of devices, such as the device 200, the user devices 104-1, 104-2, and 104-n and the imaging device 300, for the ease of explanation, the present description of the example method 600 is provided in reference to the above-described imaging device 300.

The order in which the method 600 is described is not intended to be construed as a limitation, and any number of the described method blocks may be combined in any order to implement the method 600, or an alternative method.

It may be understood that blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 6, at block 602, an ethernet controller, such as the ethernet controller 308 of the imaging device 300 receives a data packet from a physical network 312. In an example, a MAC layer module of the ethernet controller, such as the MAC layer module 310 of the ethernet controller 308 of the imaging device 300 receives the data packet. The data packet may be sent by another device, such as the user devices 104-1, 104-2, and 104-n through the physical network 312.

At block 604, it is determined whether the first processor 304 is active or operating in the power saving mode. The first processor 304 may be incorporated in a multi-processor core coupled to the ethernet controller 308 of the imaging device 300. In an example, a driver of the second processor 306 such as the second driver 316 is configured to make this determination, which in turn notifies the MAC layer module 310 about the operating state of the first processor 304.

If the determination at block 604 is in the affirmative, at block 606, a further determination is made as to whether the received data packet is to be processed by the first processor 304 or a second processor 306 of the imaging device 300. The second processor 306 may also be incorporated in the multi-processor core 302. In an example, the MAC layer module 310 may make this determination.

Based upon a determination that the data packet is to be processed by the first processor 304, the method 600 proceeds to block 608. At block 608, the data packet is sent to a first DMA channel of the ethernet controller 308. The first DMA channel may be the first DMA channel 402 incorporated in the ethernet controller 308 of the imaging device 300. In an example, the MAC arbiter 416 may send the data packet to the first DMA channel 402. The method 600 further proceeds to block 610, where the data packets are retrieved through the first DMA channel 402 and processed by the first processor 304.

Referring back to block 606, based upon a determination that the data packet is to be processed by a second processor, such as the second processor 306 of the multi-processor core 302, rather than the first processor 304, the method 600 proceeds to block 612. At block 612, the data packet is sent to a second DMA channel of the ethernet controller, such as the second DMA channel 404 of the ethernet controller 308. In an example, the MAC arbiter 416 may send the data packet to the second DMA channel 404. At block 614, the data packet is retrieved from the second DMA channel 404 and processed by the second processor 306.

Referring again to block 604, a negative determination indicates that the first processor 304 is operating in the power saving mode. Accordingly, the method proceeds to block 616, where the data packet is sent to the second DMA channel 404. In an example, the MAC arbiter 416 may send the data packet to the second DMA channel 404. At block 618, it is determined whether the data packet sent to the second DMA channel 404 is to be processed by the first processor 304. In an example, to make such determination, the second processor 306 may retrieve the data packet from the second DMA channel 404 and analyze the same. When it is determined that the data packet is not to be processed by the first processor 304, rather is to be processed by the second processor 306, the method proceeds to block 614, where the data packet is processed by the second processor 306. Otherwise, if it is determined that the data packet retrieved from the second DMA channel 404 is to be processed by the first processor 304, then at block 620, the data packet is stored in a data structure associated with the second DMA channel 404, wherein the data structure is accessible to the first processor 304.

The second processor 306, at block 622, invokes the first processor 304 and at block 624, provides a pointer to the data structure where the data packet is stored in the first processor 304. The method then proceeds to block 626, where the first processor 304 retrieves the data packet from the data structure. Finally, at block 628, the first processor 304 processes the data packet. Accordingly, the transition of the first processor 304 from the power saving mode to an active mode is performed in minimum transition time without losing data packets.

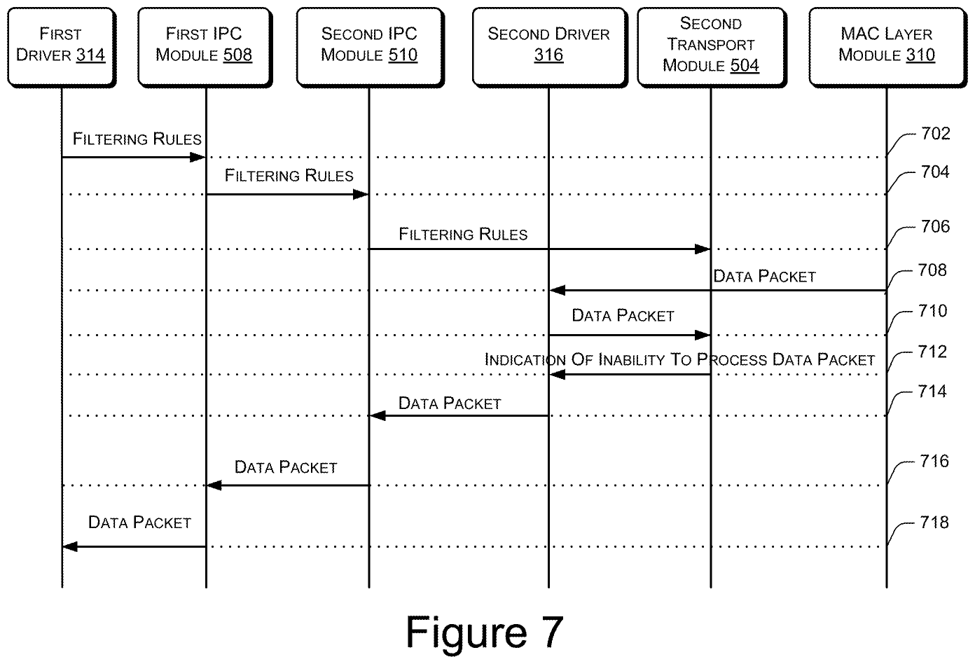

Reference is now made to FIG. 7, illustrating, according to an example implementation of the present subject matter, a communication flow that takes place in order to make a determination at step 618 of the FIG. 6, i.e., whether the data packet received from the physical network 312 is to be processed by the first processor 304 when the first processor 304 is operating in the power saving mode. Initially at step 702, a first driver 314 of the first processor 304 sends filtering rule to a first IPC module 508 of the first processor 304. As mentioned above, the filtering rules are dynamically configured and defined by the first processor 304 to indicate types of data packets to be processed by the second processor 306. At step 704, the first IPC module 508 transmits the filtering rules to the second IPC module 510 of the second processor 306 which at step 706, in turn transmits the filtering rules to the second transport module 504 of the second processor 306 to enable the second transport module 504 to determine whether the data packet is to be processed by the first processor 304. At step 708, the second driver 316 receives the data packet from the MAC layer module 310.

Further, at step 710, the second driver 316 sends the data packet to the second transport module 504. The second transport module 504 then analyzes the data packet and determines whether the data packet is to be handled by the first processor 304 or the second processor 306 based on the filtering rules. If it is determined that the second processor 306 is unable to process the data packet and the data packet is to be processed by the first processor 304, then at step 712, the second transport module 504 sends an indication of its inability to process the data packet to the second driver 316. On receiving such an indication, the second driver 316, at step 714, sends the data packet to the second IPC module 510 which in turn, at step 716, sends the data packet to the first IPC module 508. The first IPC module 508, at step 718, sends the data packet to the first driver 314. The first processor 304 may then process the data packet. However, if it is determined by the second transport module 504 that the second processor 306 can handle the data packet, then the second transport module 504 may inform the second driver 316 about the same and the second processor 306 may accordingly process the data packet. Since, the first processor 304 does not always need to be invoked by the second driver 316 on receiving a data packet addressed to the first processor 304, this results in saving the power consumed by the first processor 304 which is more powerful and consumes more power than the second processor 306.

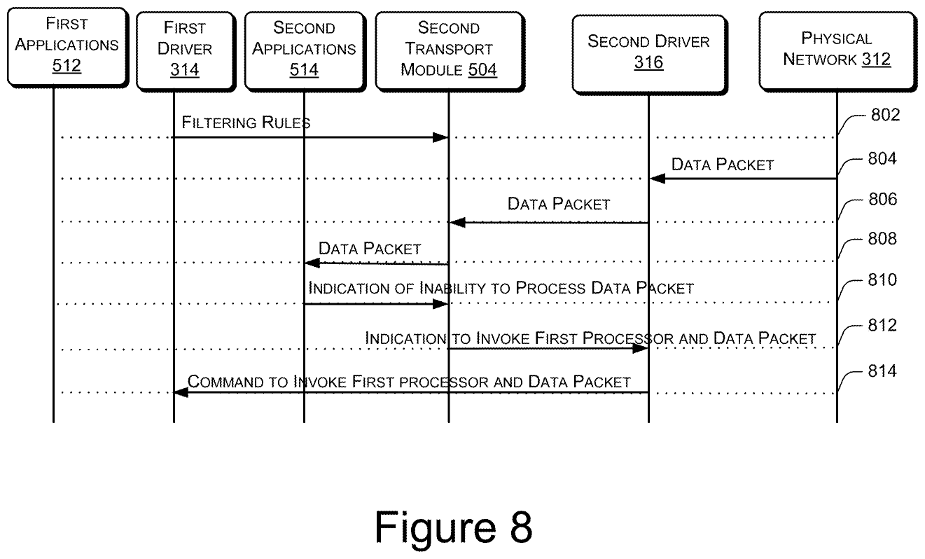

Reference is now made to FIG. 8, illustrating, according to an example implementation of the present subject matter, a communication flow that takes place in a scenario where the first and second applications 512, 514 of the respective processors coordinate to process the data packets received from the physical network 312. At the initiation of the process, at step 802, the first driver 314 of the first processor 304 sends filtering rules to the second transport module 504 of the second processor 306 for configuring the packet inspection module 506. The filtering rules are transferred to the packet inspection module 506 following steps 702 through 706 as explained above in reference to FIG. 7. As explained above, the first driver 314 sends the filtering rules to the second transport module 504 through an IPC channel formed by a first IPC module 508 of the first processor 304 and a second IPC module 510 of the second processor 306. For simplicity, these components and the communication that takes place among these components have been omitted from FIG. 8.

At step 804, the second driver 316 receives the data packet from the physical network 312 and at step 806, transmits the data packet to the second transport module 504 which analyzes the data packet and based upon the filtering rules received from the first driver 314 determines whether the data packet is to be processed by the first processor 304 or the second processor 306. If it is determined that the data packet is to be processed by the second processor 306, the second transport module 504, at step 808, sends the data packet to an appropriate application in the second applications 514 installed in the second processor 306. As mentioned previously, the second applications 514 may comprise management applications 520 and discovery applications 522. The respective application in the second applications 514 then determines whether it can handle the data packet or not. As mentioned previously, the first and the second applications 512, 514 have distributed architecture, i.e., an application in the second applications 514 may have limited features as compared to its counterpart application in the first application 512. Accordingly, based upon its capabilities to process the data packet, the respective application in the second application 514 may determine whether it can handle the data packet or not. For example, if a discovery packet is received by the discovery application 522 in the second application 514, it compares its capabilities with a configuration of the data packet and determines if it can process and respond to the data packet or not. If the second application 514 is unable to process the data packet, at step 810, it sends an indication of its inability to process the data packet to the second transport module 504. Accordingly, at step 812, the second transport module 504 sends an indication to invoke the first processor 304 and the data packet to the second driver 316. Finally, at step 814, the second driver 316 sends a command to invoke the first processor 304 and the data packet to the first driver 314.

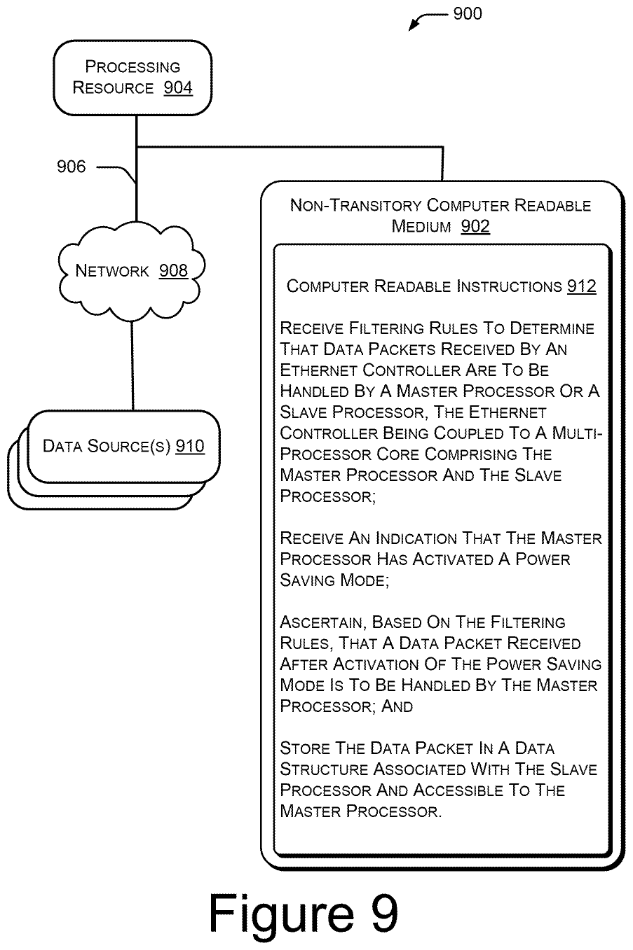

FIG. 9 illustrates a computing environment 900 implementing a non-transitory computer-readable medium 902 for operating a processor in a power saving mode, according to an example of the present subject matter.

In an example, the computing environment 900 may comprise any of the above-explained imaging device 300. The computing environment 900 includes a processing resource 904 communicatively coupled to the non-transitory computer-readable medium 902 through a communication link 906. In an example, the processing resource 904 may be a processor of the imaging device 300 that fetches and executes computer-readable instructions from the non-transitory computer-readable medium 902.

The non-transitory computer-readable medium 902 may be, for example, an internal memory device or an external memory device. In an example, the communication link 906 may be a direct communication link, such as any memory read/write interface. In another example, the communication link 906 may be an indirect communication link, such as a network interface. In such a case, the processing resource 904 may access the non-transitory computer-readable medium 902 through a network 908. The network 908 may be a single network or a combination of multiple networks and may use a variety of different communication protocols.

The processing resource 904 and the non-transitory computer-readable medium 902 may also be communicatively coupled to data source(s) 910. The data source(s) 910 may be used to store details, such as data packets, in an example. In an example, the non-transitory computer-readable medium 902 comprises computer readable instructions 912 for operating a processor in a power saving mode. For example, the non-transitory computer-readable medium 902 may comprise the computer readable instructions 912 that may executed to implement the previously described MAC layer module 310 and first and second drivers 314, 316.

In an example, the computer readable instructions 912 may cause the processing resource 904 to receive filtering rules to determine that data packets received by an ethernet controller 308 of the imaging device 300, through a physical network 312, are to be handled by a master processor such as the first processor 304 or a slave processor such as the second processor 306. As explained previously, the ethernet controller 308 may be coupled to the multi-processor core 302 comprising the master processor and the slave processor, such as the first and second processor 304, 306 of the imaging device 300. Further, as described above, the filtering rules are defined by the master processor 304 to indicate types of data packets to be processed by the slave processor 306.

The computer readable instructions 912 may further cause the processing resource 904 to receive an indication that the master processor 304 has activated a power saving mode. As explained previously, a driver of the master processor 304 such as the first driver 314 of the first processor 304 of the imaging device 300 may send such an indication.

Further, the computer readable instructions 912 may cause the processing resource 904 to ascertain, based on the filtering rules, that a data packet received after activation of the power saving mode is to be handled by the master processor 304. The instructions may further cause the processing resource 904 to store the data packet in a data structure associated with the slave processor 306 and accessible to the master processor 304.

In an example implementation, when the master processor 304 is operating in the power saving mode and if it is determined that the data packet is to be processed by the master processor 304, then the computer readable instructions 912 may cause the processing resource 904 to invoke the master processor 304 to process the data packet and to provide an address of the data structure where the data is stored in the master processor 304. Accordingly, the master processor 304 may retrieve and process the data packet.

Accordingly, the processor of the imaging device 300 may operate in a power saving mode without losing the data packets addressed to it and may undergo a transition from the power saving mode to the active mode within a minimum time period.

Thus, the methods and devices of the present subject matter provide techniques for dynamic power management in devices having a multi-processor core. Although implementations have been described in a language specific to structural features and/or methods, it is to be understood that the appended claims are not necessarily limited to the specific features or methods described. Rather, the specific features and methods are disclosed as example for operating a master processor of the device in a power saving mode, such that the process of transition of the master processor from the power saving mode to an active mode eliminates loss of data packets and minimizes the transition time involved.

1. A device comprising:
an application specific integrated circuit comprising:
a master processor, the master processor is to operate in one of a power saving mode or an active mode;
a slave processor communicatively coupled to the master processor;
an ethernet controller communicatively coupled to the application specific integrated circuit, the ethernet controller comprising:
a first direct memory access channel associated with a first data structure accessible to the master processor;
a second direct memory access channel associated with a second data structure accessible to the master processor and the slave processor;
a MAC layer module to receive a data packet through a physical network, wherein the MAC layer module is to transfer the data packet to one of the first direct memory access channel and the second direct memory access channel based upon a determination that the data packet is addressed to the master processor or slave processor, respectively, when the master processor is operating in the active mode; and based upon an indication from the slave processor to transfer data packet to the second direct memory access channel when the master processor is operating in the power saving mode,
wherein the corresponding first direct memory access channel and second direct memory access channel store the data received from the MAC layer module in the first data structure and the second data structure, respectively.

2. The computing device as claimed in claim 1, wherein the slave processor further comprises a transport module and wherein, when the master processor is operating in the power saving mode, the transport module is to:
determine whether the data packet received from the MAC layer module is to be handled by one of the master processor and the slave processor; and
cause the master processor to be invoked to process the data packet based on the determination.

3. The computing device as claimed in claim 2, wherein the transport module comprises a packet inspection module to inspect data packets transferred to the second channel when the master processor operates in the power saving mode, and wherein the packet inspection module is to:
make the determination of whether the data packet received from the MAC layer module is to be handled by the master processor or the slave processor based on filtering rules, the filtering rules being indicative of types of data packets that are to be handled at the slave processor.

4. The computing device as claimed in claim 3, wherein the filtering rules are provided to the packet inspection module by the master processor.

5. The computing device as claimed in claim 3, wherein the slave processor comprises at least one application, and wherein the at least one application is to:
receive the data packet from the transport module, upon the packet inspection module making the determination that the data packet received from the MAC layer module is to be processed by the slave processor.

6. The computing device as claimed in claim 5, wherein the at least one application is to process the data packet or cause transfer of the data packet to a corresponding application residing in the master processor.

7. The computing device as claimed in claim 1, wherein the master processor is to send an indication to the slave processor on the first master entering the power saving mode.

8. The computing device as claimed in claim 2, wherein the slave processor is to send an address of the second data structure, where the data packet is stored, to the master processor upon the determination of invoking the master processor is made.

9. An imaging device comprising:
an ethernet controller comprising a MAC layer module, wherein the MAC layer module to receive data packet through a physical network;
a multi-processor core coupled to the ethernet controller and comprising at least a first processor and a second processor, the first processor and the second processor comprising a first driver and a second driver, respectively, wherein the second driver is to:
determine that the first processor has entered a power saving mode;
receive data packet directed towards the multi-processor core from the MAC layer module and store the data packet in a data structure; and
invoke, based on a determination that the data packet is to be handled by the first processor, the first driver and provide an address of the data structure storing the data packet to the first driver, the data structure being accessible by the first driver to retrieve the data packet.

10. The imaging device as claimed in claim 9, wherein the second processor comprises a second transport module coupled to the second driver, wherein the transport module is to determine whether the data packet received from the MAC layer module is to be handled by the master processor or the slave processor when the master processor is operating in the power saving mode; and
cause the master processor to be invoked to process the data packet based on the determination.

11. The imaging device as claimed in claim 10, wherein the second transport module is to determine whether the data packet received is to be handled by the master processor or the slave processor based on filtering rules, with the filtering rules being defined by the master processor and are to indicate types of data packets to be processed by the slave processor.

12. The imaging device as claimed in claim 11, wherein the filtering rules are modifiable by the master processor at run-time.

13. The imaging device as claimed in claim 11, wherein the first driver of the first processor is to send an indication to the second processor upon the first processor initiating a power saving mode, the filtering rules being provided to the second transport module of the slave processor by the master processor prior to the indication.

14. A non-transitory computer-readable medium comprising instructions executable by a processing resource to:
receive filtering rules to determine that data packets received by an ethernet controller, through a physical network, are to be handled by a master processor or a slave processor, the ethernet controller being coupled to a multi-processor core comprising the master processor and the slave processor;
receive an indication that the master processor has activated a power saving mode;
ascertain, based on the filtering rules, that a data packet received after activation of the power saving mode is to be handled by the master processor; and
store the data packet in a data structure associated with the slave processor and accessible to the master processor.

15. The non-transitory computer-readable medium as claimed in claim 14, further comprising instructions executable by the processing resource to:
invoke the master processor to process the data packet; and
provide an address of the data structure where the data packet is stored to the master processor.
